(19) United States
(12) Patent Application Publication
(10) Pub. No.: US 2017/0048768 A1
(43) Pub. Date: Feb. 16, 2017

(54) HANDOFF PROCEDURES IN MOBILE DEVICES

(71) Applicant: QUALCOMM Incorporated, San Diego, CA (US)

(72) Inventors: Vamsi Krishna Chaitanya Komati, Hyderabad (IN); Bhaskara Viswanadham Batchu, Hyderabad (IN)

(21) Appl. No.: 14/821,868

(22) Filed: Aug. 10, 2015

(51) Int. Cl. H04W 36/06

(52) U.S. Cl. CPC H04W 36/06; H04W 36/18

(57) ABSTRACT

Various embodiments include methods implemented on a mobile communication device for performing a handoff from a first subscription on a mobile communication device to a second subscription, the mobile device having a transceiver and a receiver. The methods may include receiving, on the mobile communication device, a request from a network to perform a handoff of a data call from the first subscription to the second subscription, performing, via the receiver, the handoff of the data call to the second subscription while maintaining, via the transceiver, the data call on the first subscription during the handoff of the data call to the second subscription, determining whether the handoff of the data call to the second subscription was successful, and terminating the data call on the first subscription in response to determining that the handoff of the data call to the second subscription was successful.

### BACKGROUND

Some designs of mobile communication devices—such as smart phones, tablet computers, and laptop computers—contain one or more Subscriber Identity Module (SIM) cards that provide users with access to multiple separate mobile telephony networks. Examples of mobile telephony networks include Third Generation (3G), Fourth Generation (4G), Long Term Evolution (LTE), Time Division Multiple Access (TDMA), Frequency Division Multiple Access (FDMA), Code Division Multiple Access (CDMA), Wideband CDMA (WCDMA), Time Division Synchronous CDMA (TD-SCDMA), Global System for Mobile Communications (GSM), Universal Mobile Telecommunications Systems (UMTS), evolved High Speed Packet Access (HSPA+), Dual-Cell High Speed Packet Access (DC-HSPA), Evolution Data-Optimized (EV-DO), Enhanced Data rates for GSM Evolution (EDGE), and single carrier Radio Transmission Technologies (1×RTT).

A mobile communication device that includes one or more SIMs and connects to two or more separate mobile telephony networks using one or more shared radio frequency (RF) resources/radios may be termed a multi-SIM mobile communication device. One example is a dual-SIM-dual-standby (DSDS) communication device, which includes two SIM cards/subscriptions that are each associated with a separate radio access technology (RAT), and the separate RATs share one RF resource chain to communicate with two separate mobile telephony networks on behalf of their respective subscriptions. When one RAT is using the RF resource, the other RAT is in stand-by mode and is not able to communicate using the RF resource.

Certain advanced RATs may have additional features. For example, an LTE mobile telephony network may be able to support more than one data call or transmit/receive chains using only one RF resource through carrier aggregation. A multi-SIM communication device may have an RF resource that supports a primary component carrier (PCC) and one or more secondary component carriers (SCC). The PCC may include an uplink carrier channel and a downlink carrier channel on a primary cell, and each SCC may be a downlink carrier channel on secondary cells.

### SUMMARY

Various embodiments include methods implemented on a mobile communication device for performing a handoff from a first subscription to a second subscription, the mobile communication device having a transceiver and a receiver. In various embodiments the methods may include receiving, on the mobile communication device, a request from a network to perform a handoff of a data call from the first subscription to the second subscription, performing, via the receiver, the handoff of the data call to the second subscription while maintaining, via the transceiver, the data call on the first subscription during the handoff of the data call to the second subscription, determining whether the handoff of the data call to the second subscription was successful, and terminating the data call on the first subscription in response to determining that the handoff of the data call to the second subscription was successful.

In some embodiments, terminating the data call on the first subscription may include terminating the data call maintained by the first subscription via the transceiver and establishing the data call on the transceiver through the second subscription.

Some embodiments may further include maintaining the data call on the first subscription in response to determining that the handoff of the data call to the second subscription has not succeeded. In some embodiments, the first subscription may be associated with a first radio access technology (RAT) and the second subscription may be associated with a second RAT. In such embodiments, the second RAT may have a higher data throughput than the first RAT. In some embodiments, the transceiver may be utilized by the first RAT and the second RAT, and the receiver may be utilized by the second RAT.

Further embodiments include a mobile communication device including a memory and a processor configured with processor-executable instructions to perform operations of the methods described above. Further embodiments include a non-transitory processor-readable storage medium having stored thereon processor-executable software instructions configured to cause a processor to perform operations of the methods described above. Further embodiments include a mobile communication device that includes means for performing functions of the operations of the methods described above.

### BRIEF DESCRIPTION OF THE DRAWINGS

The accompanying drawings, which are incorporated herein and constitute part of this specification, illustrate exemplary aspects of various embodiments, and together with the general and detailed descriptions given herein, serve to explain the features of various embodiments.

FIG. 1A is a communication system block diagram of a network suitable for use with various embodiments.

FIG. 1B is system block diagram of an Evolved Packet System (EPS) suitable for use with various embodiments.

FIG. 2 is a block diagram illustrating a mobile communication device according to various embodiments.

FIG. 3 is a block diagram illustrating a communication subsystem in a mobile communication device according to various embodiments.

FIG. 4 is a call diagram illustrating conventional handoff procedures in a mobile communication device.

FIGS. 5A and 5B are timing diagrams for conventional handoff procedures in a mobile communication device.

FIG. 6 is a call diagram illustrating improved handoff procedures in a mobile communication device according to various embodiments.

FIGS. 7A and 7B are timing diagrams for improved handoff procedures in a mobile communication device according to various embodiments.

FIG. 8 is a process flow diagram illustrating a method for performing a handoff procedure in a mobile communication device according to various embodiments.

FIG. 9 is a component diagram of an example mobile communication device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the embodiments or the claims.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a mobile communication device on a network and enable a communication service with the network. Because the information stored in a SIM enables the mobile communication device to establish a communication link for a particular communication service or services with a particular network, the term “SIM” is also be used herein as a shorthand reference to the communication service associated with and enabled by the information stored in a particular SIM as the SIM and the communication network, as well as the services and subscriptions supported by that network, correlate to one another. Similarly, the term SIM may also be used as a shorthand reference to the protocol stack and/or modem stack and communication processes used in establishing and conducting communication services with subscriptions and networks enabled by the information stored in a particular SIM.

As used herein, the terms “mobile communication device,” “multi-SIM mobile communication device,” “multi-SIM communication device,” “mobile device”, and “multi-SIM device” are used interchangeably to describe a mobile communication device that is configured with more than one SIM.

The terms “network,” “wireless network,” “cellular network,” and “cellular wireless communication network” are used interchangeably herein to refer to a portion or all of a wireless network of a carrier associated with a mobile communication device and/or subscription on a mobile communication device.

Wireless communication networks are widely deployed to provide various communication services such as voice, packet data, broadcast, messaging, and so on. These wireless networks may be capable of supporting communications for multiple users by sharing the available network resources. Examples of such wireless networks include LTE, GSM, CDMA, TDMA, FDMA 1×RTT, W-CDMA, CDMA2000, etc.

Modern mobile communication devices (e.g., smartphones) may each include one or more SIM cards containing SIMs that enable a user to connect to different mobile networks while using the same mobile communication device. Each SIM serves to identify and authenticate a subscriber using a particular mobile communication device, and each SIM is associated with only one subscription. For example, a SIM may be associated with a subscription to one of LTE, GSM, TD-SCDMA, CDMA2000, and WCDMA.

The terms “receiver” and/or “transmitter” may indicate an RF chain and/or portions of the RF receive chain in use for radio links. Such portions of the RF chain may include, without limitation, an RF front end, components of the RF front end (including a receiver unit and/or transmitter unit), antennas, etc. Portions of the RF chain may be integrated into a single chip, or distributed over multiple chips. Also, the RF resource, the RF chain, or portions of the RF chain may be integrated into a chip along with other functions of the mobile communication device. Further, in some embodiment wireless systems, the mobile communication device may be configured with more RF chains than spatial streams, thereby enabling receive and/or transmit diversity to improve signal quality.

A mobile communication device may have one RF resource that supports multiple SIMs. For example, in a dual-SIM-dual-standby (DSDS) device the mobile communication device supports two SIMs that share one RF resource. One SIM may support an advanced communications network, such as an LTE subscription, while the other SIM may support a legacy communications network, such as GSM, CDMA, or WCDMA. The RF resource may be capable of supporting carrier aggregation for the LTE subscription. That is, the LTE subscription may include a number of carriers, including a primary component carrier (PCC) and one or more secondary component carriers (SCC). The primary cell of the PCC includes a primary uplink and downlink carrier for the subscription, while the secondary cells of the SCCs may be used as additional receive chains (downlink carriers) in order to increase data throughput. The LTE subscription may support carrier aggregation in order to implement the multi-carrier communication features of the LTE subscription.

In a DSDS mobile communication device, the active subscription may be in communication with a network base station, for example during a data call. The network may send a request to the mobile communication device to perform a handoff from the active subscription to the idle subscription. For example, the active subscription may be using a GSM RAT and the network may request a handoff to the idle subscription that uses a LTE RAT in order to enable service with a higher data throughput.

Conventionally, during a handoff procedure, the active subscription terminates the data call with the network before the idle subscription attempts to connect with the network. If the handoff is successful, the idle subscription becomes active and resumes the data call. However, if the handoff is unsuccessful, the active subscription must reacquire service with the network to resume the data call. Failures in handoff may occur, for example, if the idle subscription is near a cell boundary of a network base station. This may cause the handoff procedure to take a longer amount of time and increases the probability of failure because of the distance and the weakness of the signal. During the handoff none of the subscriptions on the mobile communication device are supporting the data call. This results in a disruption in service during the handoff procedure, which may last for a long time, especially if the handoff procedure fails and service must be reacquired on the active subscription.

A network base station may initiate a handoff procedure between an active subscription that is currently supporting a data call and an idle subscription. For example, the active subscription may be using a GSM RAT and the network may request a handoff to the idle subscription that uses a LTE RAT in order to enable service with a higher data throughput. During the handoff procedure, the active subscription terminates the data call with the network base station before the idle subscription attempts to connect with an appropriate network base station. If the handoff is successful, the idle subscription becomes active and resumes the data call. However, if the handoff is unsuccessful, the active subscription must reacquire service with the network to resume the data call. During the handoff none of the subscriptions on the mobile communication device are supporting the data call. This results in a disruption in service during the handoff procedure, which may last for a long time, especially if the handoff procedure fails and service must be reacquired on the active subscription.

Systems, methods, and devices of various embodiments enable a mobile communication device to maintain the data call while performing a handoff procedure between subscriptions. A mobile communication device processor may receive a request from a network to perform a handoff of a data call from an active first subscription to an idle second subscription. The device processor may perform the handoff of the data call to the second subscription using an RF resource of the mobile communication device while the RF resource maintains the data call on the first subscription during the handoff procedure. The RF resource may include a transceiver that is used to maintain the data call on the first subscription, and a separate receiver that is used to perform the handoff procedure with the second subscription.

The device processor may determine whether the handoff of the data call to the second subscription has succeeded. If the handoff procedure has succeeded, the device processor may terminate the data call on the first subscription. For example, the first subscription may cease use of the transceiver so that the second subscription may switch from the receiver to the transceiver to establish the data call. If the handoff procedure has not succeeded, the device processor may continue to maintain the data call on the first subscription.

In the following descriptions of various embodiments, references may be made to a first subscription and a second subscription and corresponding first carriers and second carriers. The references to the first and second subscriptions or first and second carriers are arbitrary and used merely for the purposes of describing the embodiments. The mobile communication device processor may assign any indicator, name or other designation to differentiate the subscriptions associated with one or more SIMs, and to differentiate the carriers used by a subscription. Further, while the high-speed network is referenced as an LTE network, various embodiments may be implemented for receiving data in any of a variety of high-speed networks (e.g., HSPA+, DC-HSPA, EV-DO, etc.).

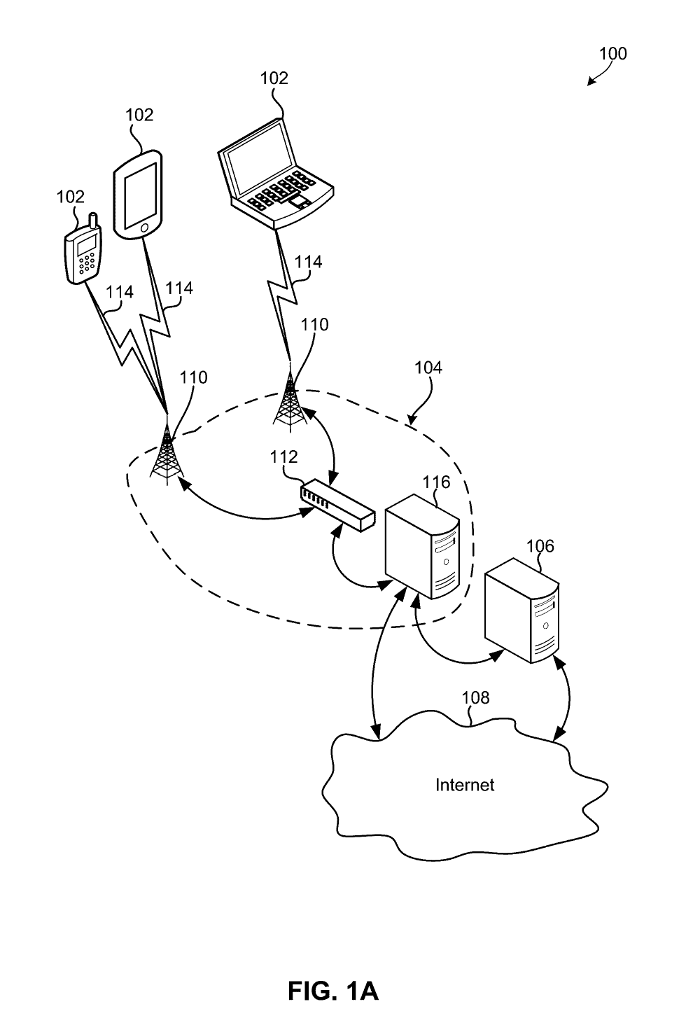

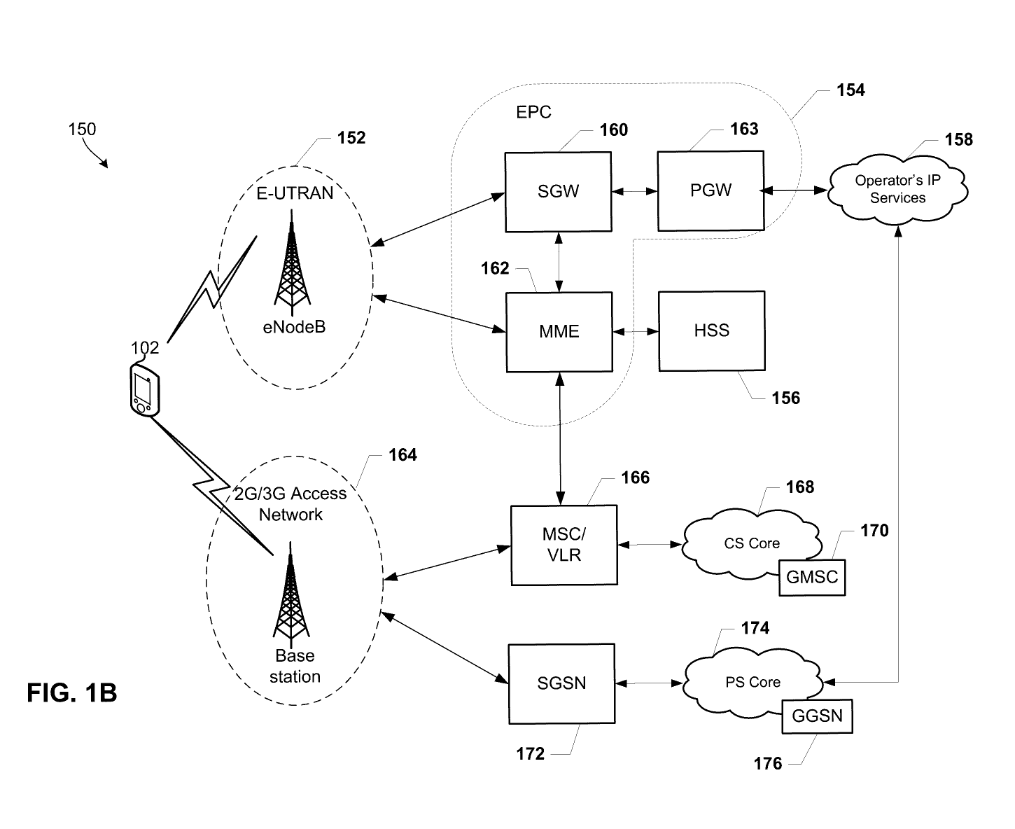

Various embodiments may be implemented within a variety of communication systems, such as example communication system 100 illustrated in FIG. 1A. The communication system 100 may include one or more mobile communication devices 102, a telephone network 104, and network servers 106 coupled to the telephone network 104 and to the Internet 108. In some embodiments, the network server 106 may be implemented as a server within the network infrastructure of the telephone network 104.

A typical telephone network 104 may include a plurality of cell base stations 110 coupled to a network operations center 112, which operates to connect voice and data calls between the mobile communication devices 102 (e.g., tablets, laptops, cellular phones, etc.) and other network destinations, such as via telephone land lines (e.g., a plain old telephone service (POTS) network, not shown) and the Internet 108. The telephone network 104 may also include one or more servers 116 coupled to or within the network operations center 112 that provide a connection to the Internet 108 and/or to the network servers 106. Communications between the mobile communication devices 102 and the telephone network 104 may be accomplished via two-way wireless communication links 114, such as GSM, UMTS, EDGE, 4G, 3G, CDMA, TD-SCDMA, TDMA, 1×RTT, LTE, and/or other communication technologies.

In general, any number of wireless networks may be deployed in a given geographic area. Each wireless network may support one or more radio access technology, which may operate on one or more frequency (also referred to as a carrier, channel, frequency channel, etc.) in the given geographic area in order to avoid interference between wireless networks of different radio access technologies.

Upon power up, the mobile communication device 102 may search for wireless networks from which the mobile communication device 102 can receive communication service. In various embodiments, the mobile communication device 102 may be configured to prefer LTE networks when available by defining a priority list in which LTE frequencies occupy the highest spots. The mobile communication device 102 may perform registration processes on one of the identified networks (referred to as the serving network), and the mobile communication device 102 may operate in a connected mode to actively communicate with the serving network.

Alternatively, the mobile communication device 102 may operate in an idle mode and camp on the serving network if active communication is not required by the mobile communication device 102. In the idle mode, the mobile communication device 102 may identify all radio access technologies in which the mobile communication device 102 is able to find a “suitable” cell in a normal scenario or an “acceptable” cell in an emergency scenario, as specified in the LTE standards, such as 3GPP TS 36.304 version 8.2.0 Release 8, entitled “LTE; Evolved Universal Terrestrial Radio Access (E-UTRA); User Equipment (UE) procedures in idle mode.”

The mobile communication device 102 may camp on a cell belonging to the RAT with the highest priority among all identified cells. The mobile communication device 102 may remain camped until either a control channel no longer satisfies a threshold signal strength or a cell of a higher priority RAT reaches a threshold signal strength. Such cell selection/reselection operations for the mobile communication device 102 in the idle mode are described in 3GPP TS 36.304 version 8.2.0 Release 8.

FIG. 1B illustrates a network architecture 150 that includes an Evolved Packet System (EPS). With reference to FIGS. 1A-1B, in the network architecture 150 the mobile communication device 102 may be connected to an LTE access network, for example, an Evolved UMTS Terrestrial Radio Access Network (E-UTRAN) 152. In various embodiments, the E-UTRAN 152 may be a network of LTE base stations (i.e., eNodeBs) (e.g., eNodeB 110), which may be connected to one another via an X2 interface (e.g., backhaul) (not shown).

In various embodiments, each eNodeB 110 may provide to mobile communication devices an access point to an LTE core (e.g., an Evolved Packet Core). For example, the EPS in the network architecture 150 may further include an Evolved Packet Core (EPC) 154 to which the E-UTRAN 152 may connect. In various embodiments, the EPC 154 may include at least one Mobility Management Entity (MME) 162, a Serving Gateway (SGW) 160, and a Packet Data Network (PDN) Gateway (PGW) 163.

In various embodiments, the E-UTRAN 152 may connect to the EPC 154 by connecting to the SGW 160 and to the MME 162 within the EPC 154. The MME 162, which may also be logically connected to SGW 160, may handle tracking and paging of the mobile communication device 102 and security for E-UTRAN access on the EPC 154. The MME 162 may be linked to a Home Subscriber Server (HSS) 156, which may support a database containing user subscription, profile, and authentication information. Further, the MME 162 provides bearer and connection management for user Internet protocol (IP) packets, which are transferred through the SGW 160.

In various embodiments, the SGW 160 may be connected to the PGW 163, which may provide IP address allocation to the mobile communication device 102, as well as other functions. The PGW 163 may be connected to the Operator's IP Services 158, which may include, for example, the Internet, an Intranet, an Internet protocol Multimedia Subsystem (IMS), a Packet switched Streaming Service (PSS), etc.

The network architecture 150 may also include circuit-switched (CS) and packet-switched (PS) networks. In some embodiments, the mobile communication device 102 may be connected to the CS and/or PS packet switched networks by connecting to a legacy 2G/3G access network 164, which may be one or more UTRAN, GSM EDGE Radio Access Network (GERAN), etc. In various embodiments, the 2G/3G access network 164 may include a network of base stations (e.g., base transceiver stations (BTSs), nodeBs, radio base stations (RBSs), etc.) (e.g., 110), as well as at least one base station controller (BSC) or radio network controller (RNC). In various embodiments, the 2G/3G access network 164 may connect to the circuit switched network via an interface with (or gateway to) a Mobile Switching Center (MSC) and associated Visitor Location Register (VLR), which may be implemented together as MSC/VLR 166. In the CS network, the MSC/VLR 166 may connect to a CS core 168, which may be connected to external networks (e.g., the public switched telephone network (PSTN)) through a Gateway MSC (GMSC) 170.

In various embodiments, the 2G/3G access network 164 may connect to the PS network via an interface with (or gateway to) a Serving GPRS support node (SGSN) 172, which may connect to a PS core 174. In the PS network, the PS core 174 may be connected to external PS networks, such as the Internet and the Operator's IP services 158 through a Gateway general packet radio service (GPRS) Support Node (GGSN) 176.

A number of techniques may be employed by LTE network operators to enable voice calls to the mobile communication device 102 when camped on the LTE network (e.g., EPS). The LTE network (e.g., EPS) may co-exist in mixed networks with the CS and PS networks, with the MME 162 serving the mobile communication device 102 for utilizing PS data services over the LTE network, the SGSN 172 serving the mobile communication device 102 for utilizing PS data services in non-LTE areas, and the MSC/VLR 166 serving the mobile communication device 102 for utilizing voice services. In various embodiments, the mobile communication device 102 may be able to use a single RF resource for both voice and LTE data services by implementing circuit-switched fallback (CSFB) to switch between accessing the E-UTRAN 152 and the legacy 2G/3G access network 164.

The mixed network may be enabled to facilitate CSFB via an interface between the MME 162 and the MSC/VLR 166. The interface enables the mobile communication device 102 to utilize a single RF resource to be both CS and PS registered while camped on the LTE network, which enables delivery CS pages via the E-UTRAN 152. A CS page may initiate the CSFB procedure, which may cause the mobile communication device to transition to the CS network and utilize the CS call setup procedures.

In various embodiments, modulation and multiple access schemes may be employed by a high speed access network (e.g., E-UTRAN 152), and may vary depending on the particular telecommunications standard being deployed. For example, in LTE applications, orthogonal frequency-division multiplexing (OFDM) may be used on the downlink, while single-carrier frequency-division multiple access (SC-FDMA) may be used on the uplink to support both frequency division duplexing (FDD) and time division duplexing (TDD). Those of ordinary skill in the art will appreciate that while various embodiments herein may be described with respect to LTE, such embodiments but may be extended to other telecommunication standards employing other modulation and multiple access techniques.

By way of example, various embodiments may be extended EV-DO and/or Ultra Mobile Broadband (UMB), each of which are air interface standards promulgated by the 3rd Generation Partnership Project 2 (3GPP2) as part of the CDMA2000 family to provide broadband Internet access to mobile communication devices. Various embodiments may also be extended to Universal Terrestrial Radio Access (UTRA) employing WCDMA, GSM, Evolved UTRA (E-UTRA), UMB, Institute of Electrical and Electronics Engineers (IEEE) 802.11 (Wi-Fi), IEEE 802.16 (WiMAX), IEEE 802.20, and/or Flash-OFDM employing OFDM access (OFDMA). The actual wireless communication standard and the multiple access technology employed depend on the specific application and the overall design constraints imposed on the system.

In some embodiments, access network entities (e.g., eNodeBs) may have multiple antennas supporting multiple in multiple out (MIMO) technology, thereby enabling the eNodeBs to exploit the spatial domain to support spatial multiplexing, beamforming, and/or transmit diversity. Spatial multiplexing may be used to transmit different streams of data simultaneously on the same frequency. In some instances, the data steams may be transmitted to a single mobile communication device to increase the data rate, while in other instances the data streams may be transmitted to multiple mobile communication devices to increase the overall system capacity. Specifically, an eNodeB may spatially precode each data stream, and transmit each spatially precoded data stream through multiple transmit antennas on the downlink. The spatially precoded data streams may arrive at the one or more mobile communication device with different spatial signatures, enabling recovery of the one or more data streams destined for that device. On the uplink, each mobile communication device may transmit a spatially precoded data stream, which enables the eNodeB to identify the source of each received data stream.

In some embodiments, when channel conditions are unfavorable, beamforming may be used by the eNodeB to focus transmission energy in one or more directions. In various embodiments, beamforming may involve spatially precoding the data for transmission through multiple antennas. In some embodiments, to achieve good coverage at the edges of the cell, a single stream beamforming transmission may be used in combination with transmit diversity, which involves sending the same through multiple antennas.

Various embodiments may be implemented in LTE-Advanced wireless networks that have been deployed or that may be deployed in the future. LTE-Advanced communications typically use spectrum in up to 20 MHz bandwidths allocated in a carrier aggregation of up to a total of 100 MHz (5 component carriers) used for transmission in each direction. Such LTE-Advanced systems may utilize one or more of two types of carrier aggregation, non-continuous and continuous. Non-continuous carrier aggregation involves aggregating available component carriers (inter- or intra-band) that are separated in the frequency spectrum, while continuous carrier aggregation involves multiple available component carriers that are adjacent to each other. Both non-continuous and continuous carrier aggregation may aggregate multiple LTE/component carriers to serve a mobile communication device using the LTE-Advanced protocol.

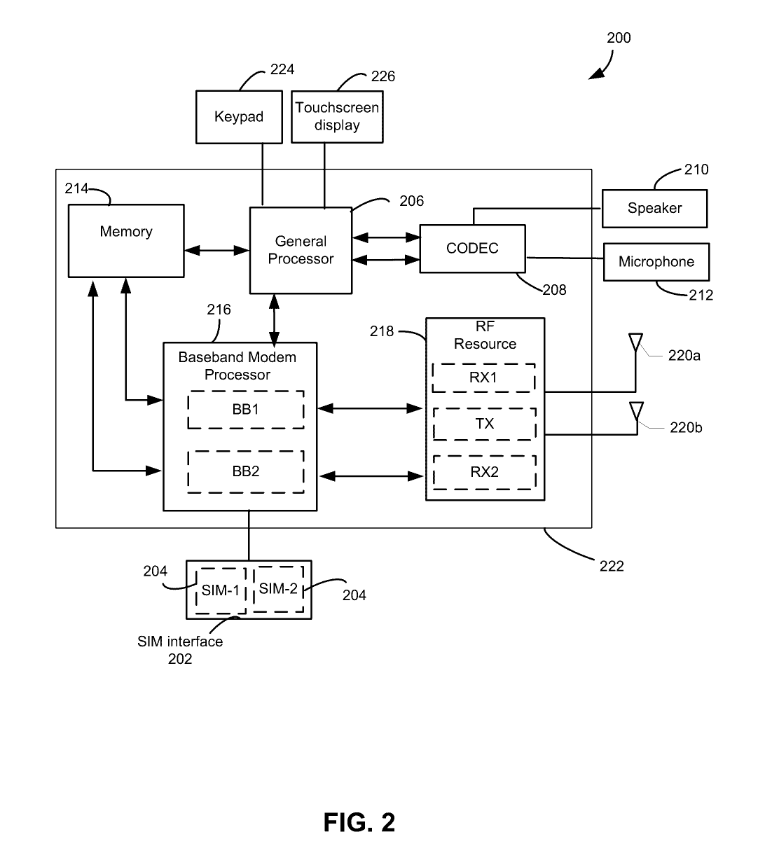

FIG. 2 is a functional block diagram of an example multi-SIM communication device 200 that is suitable for implementing various embodiments. With reference to FIGS. 1A-2, the multi-SIM communication device 200 may be similar to one or more of the mobile communication devices 102. The multi-SIM communication device 200 may include a SIM interface 202, which may include one or more SIM interfaces. The SIM interface 202 may receive a first identity module SIM 204 that is associated with the first subscription. In some embodiments, the multi-SIM communication device 200 may also include a second SIM interface as part of the SIM interface 202, which may receive a second identity module SIM 204 that is associated with a second subscription.

A SIM in various embodiments may be a Universal Integrated Circuit Card (UICC) that is configured with SIM and/or Universal SIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM 204 may have a central processing unit (CPU), read only memory (ROM), random access memory (RAM), electrically erasable programmable read only memory (EEPROM) and input/output (I/O) circuits. A SIM 204 used in various embodiments may contain user account information, an IMSI a set of SIM application toolkit (SAT) commands and storage space for phone book contacts. A SIM 204 may further store home identifiers (e.g., a System Identification Number (SID)/Network Identification Number (NID) pair, a Home Public Land Mobile Number (HPLMN) code, etc.) to indicate the SIM network operator provider. An Integrated Circuit Card Identity (ICCID) SIM serial number may be printed on the SIM card for identification.

The multi-SIM communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The memory 214 may be a non-transitory computer-readable or processor-readable storage medium that stores processor-executable instructions. For example, the instructions may include routing communication data relating to the first or second subscription though a corresponding baseband-RF resource chain. The memory 214 may store an operating system (OS), as well as user application software and executable instructions.

The general-purpose processor 206 and memory 214 may each be coupled to at least one baseband-modem processor 216. Each SIM 204 in the multi-SIM communication device 200 may be associated with a baseband-RF resource chain that includes a baseband-modem processor 216 and at least one receive block (e.g., RX1, RX2) of an RF resource 218. In various embodiments, baseband-RF resource chains may include physically or logically separate baseband modem processors (e.g., BB1, BB2).

The RF resource 218 may be coupled to antennas 220a, 220b, and may perform transmit/receive functions for the wireless services associated with each SIM 204 of the multi-SIM communication device 200. In some embodiments, the RF resource 218 may be coupled to wireless antennas 220a, 220b for sending and receiving RF signals for multiple SIMs 204 thereby enabling the multi-SIM communication device 200 to perform simultaneous communications with separate networks and/or service associated with the SIM(s) 204. The RF resource 218 may include separate receive and transmit functionalities, or may include a transceiver that combines transmitter and receiver functions. In various embodiments, the transmit functionalities of the resource 218 may be implemented by at least one transmit block (TX), which may represent circuitry associated with one or more radio access technologies/SIMs

In particular embodiments, the general-purpose processor 206, memory 214, baseband-modem processor(s) 216, and RF resource 218 may be included in a system-on-chip device 222. The one or more SIMs 204 and corresponding interface(s) 202 may be external to the system-on-chip device 222. Further, various input and output devices may be coupled to components of the system-on-chip device 222, such as interfaces or controllers. Example user input components suitable for use in the multi-SIM communication device 200 may include, but are not limited to, a keypad 224 and a touch screen display 226.

In some embodiments, the keypad 224, touch screen display 226, microphone 212, or a combination thereof, may perform the function of receiving the request to initiate an outgoing call. For example, the touch screen display 226 may receive a selection of a contact from a contact list or receive a telephone number. In another example, either or both of the touch screen display 226 and microphone 212 may perform the function of receiving a request to initiate an outgoing call. For example, the touch screen display 226 may receive selection of a contact from a contact list or receive a telephone number. As another example, the request to initiate the outgoing call may be in the form of a voice command received via the microphone 212. Interfaces may be provided between the various software modules and functions in the multi-SIM communication device 200 to enable communication between them, as is known in the art.

The baseband-modem processor of a mobile communication device may be configured to execute software including at least one protocol stack associated with at least one SIM. SIMs and associated protocol stacks may be configured to support a variety of communication services that fulfill different user requirements. Further, a particular SIM may be provisioned with information to execute different signaling procedures for accessing a domain of the core network associated with these services and for handling data thereof.

In various embodiments, the RF resource 218 may be configured with receiver and transmitter circuitry to support multiple radio access technologies or wireless networks that operate according to different wireless communication protocols. Such circuitry may allow the RF resource 218 to process signals associated with different communication standards and may include or provide connections to different sets of amplifiers, digital to analog converters, analog to digital converters, filters, voltage controlled oscillators (VCOs), etc.

In some embodiments, a first receive block (RX1) and a transmit block (TX) may operate as a pair for transmission and reception of RF signals via a first antenna in accordance with a high-speed data network, such as an LTE network. That is, various embodiments may include a first receive chain and a transmit chain that are each configured to primarily communicate with the LTE network. Further, a second receive block (RX2) may be coupled to a second antenna (i.e., forming a second receive chain), and may be configured to operate in cooperation with the transmit block and first receive block to provide dual receive capability (e.g., as used in MIMO reception). In various embodiments, the first and second receive blocks may be configured to utilize the same or different various radio receiver elements. For example, for MIMO communications, the first and second receive blocks may respectively use the first and second antennas to tune to and receive signals on the same LTE carrier frequency using a single VCO.

In some embodiments, the first and second receive blocks may respectively use the first and second antennas to tune to and receive signals on different carrier frequencies using separate VCOs. In some embodiments, a different carrier frequency may be an LTE carrier frequency in the same or in a different band, thereby providing support for an LTE wireless network that uses carrier aggregation to combine information transmitted on two or more carrier frequencies. In some embodiments in which two different carrier frequencies are received in a carrier aggregation mode, the first and second antennas may each be shared between the first and second receive blocks. In this manner, each antenna may be able to support two receive chains (i.e., one for each carrier frequency), thereby supporting antenna diversity on both carrier frequencies.

In other embodiments, the different carrier frequency may be a channel in another RAT (e.g., using a CDMA 2000 1×, UMTS, TD-SCDMA, 1×RTT, GSM). In this manner, the additional receiver may achieve a downlink connection for a legacy network simultaneous to maintaining uplink and downlink communications on the LTE network. However, with only one receive chain allocated for LTE communication, MIMO communications is disabled for downlink communications on the LTE network. As a result the mobile communication device may provide a rank indicator (RI) value in a channel status report or to provide another signaling control message to the LTE wireless network indicating an inability to decode higher Modulation and Coding Scheme (MCS) downlink data.

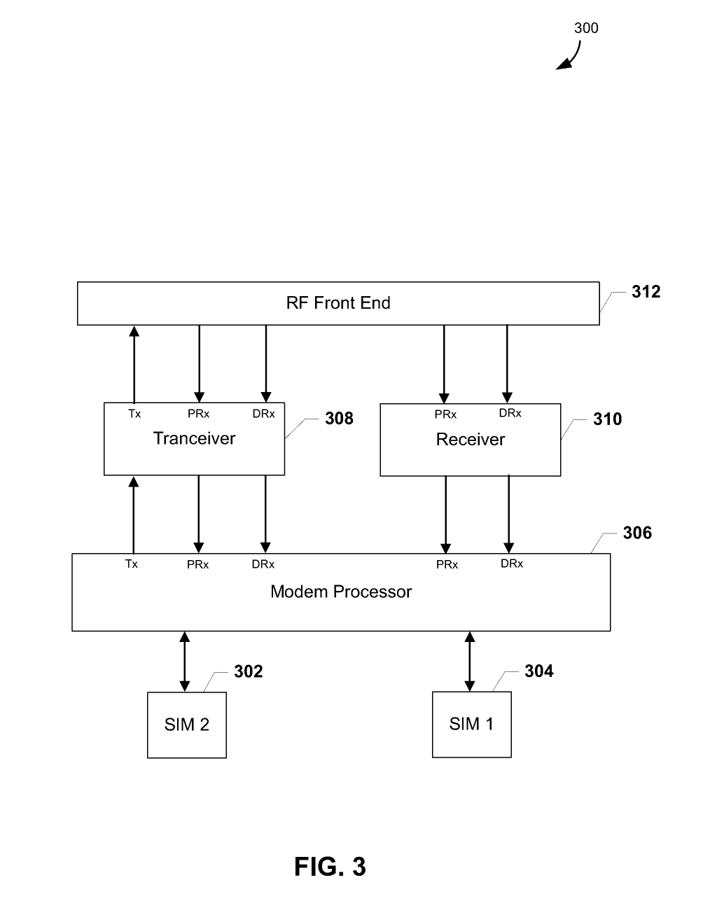

FIG. 3 is a functional block diagram of an example communications subsystem 300 in a mobile communication device (such as multi-SIM communication device 102, 200 in FIGS. 1A-2) that is suitable for implementing various embodiments. With reference to FIGS. 1A-3, the communications subsystem 300 may be coupled to a second SIM 302 and a first SIM 304. The second SIM 302 may be associated with a second subscription and a second RAT, such as LTE, that is capable of carrier aggregation and MIMO communication. The first SIM 304 may be associated with a first subscription and a first RAT, such as a legacy RAT (e.g., GSM, CDMA, or WCDMA). The second SIM 302 and the first SIM 304 may be in communication with a modem processor 306. The modem processor 306 may be in communication with a transceiver 308 and a receiver 310. The transceiver 308 and the receiver 310 may be in communication with a RF front end 312, which may include one or more antennas (e.g., 220a, 220b) used to communicate with mobile telephony networks.

The modem processor 306, the transceiver 308, the receiver 310, and the RF front end 312 may implement a number of uplink and downlink carriers for subscriptions associated with the SIMs 302, 304. For example, the modem processor 306, the transceiver 308, and the RF front end 312 may support a transmit chain Tx, primary receive chain PRx, and diversity receive chain DRx for a PCC of the second SIM 302. The modem processor 306, the receiver 310, and the RF front end 312 may also support a primary receive chain PRx and diversity receive chain DRx for a SCC of the second SIM 302. The modem processor 306, the transceiver 308, and the RF front end 312 may also support a transmit chain Tx and primary receive chain PRx for the first SIM 304 (e.g., a GSM RAT). The second SIM 302 may utilize both the transceiver 308 and the receiver 310 during communication, with the transceiver 308 supporting a PCC and the receiver 310 supporting a SCC. The first SIM 304 may only utilize the transceiver 308 during communication, and does not utilize the receiver 310.

When the subscription on the first SIM 304 is currently active and supporting a data call, the network in communication with the active subscription may request a handoff to the idle subscription of the second SIM 302. Conventionally, during a handoff procedure, the first SIM 304 terminates the data call and ceases use of the transceiver 308 so that the second SIM 302 may use the transceiver 308 to communicate with the network for the handoff. During the handoff procedure, the receiver 310 is not used by either SIM 302, 304.

However, in various embodiments, it may be possible for the first SIM 304 to maintain the data call on the transceiver 308 while the second SIM 302 utilizes the receiver 310 to perform the handoff. This allows for greater continuity in service and higher data throughput during a handoff procedure. The receiver 310 may only be utilized by the second SIM 302, and thus may be used by the second SIM 302 to perform the handoff while allowing the first SIM 304 to continue utilizing the transceiver 308 to maintain the data call during the handoff procedure.

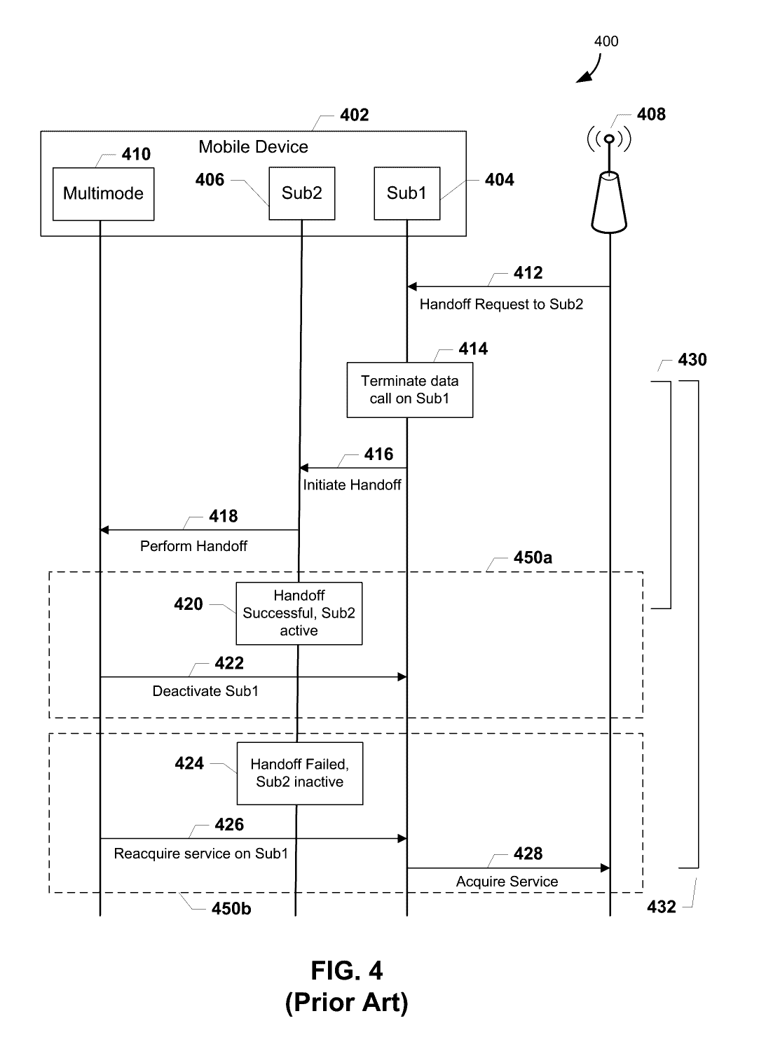

FIG. 4 illustrates a call diagram 400 for a conventional handoff procedure in a mobile communication device 402. The mobile communication device 402 includes a first subscription 404 and a second subscription 406. The mobile communication device 402 may have a communications subsystem that is similar to the communications subsystem 300 (FIG. 3). For example, the mobile communication device 402 may have a RF resource that includes a transceiver (e.g., the transceiver 308) and a receiver (e.g., the receiver 310). The first subscription 404 may utilize a RAT with lower data throughput (e.g., GSM) than the RAT of the second subscription 406 (e.g., LTE). The first subscription 404 may communicate with a network 408 to support a data call. A multimode module 410 in the mobile communication device 402 may allow the second subscription 406 to communicate with the network 408. The first subscription 404 and the second subscription 406 may communicate with the same base station of the network 408, or with different base stations controlled by the same network operator.

When the first subscription 404 is active and in communication with the network 408 using a transceiver in the mobile communication device (e.g., the transceiver 308), the network 408 may send a request 412 to the first subscription 404 to initiate a handoff procedure to the second subscription 406. For example, the network 408 may determine that a higher data throughput technology (e.g., LTE) is available for the mobile communication device 402 and may request that the mobile communication device 402 switch from the lower data throughput technology to the higher data throughput technology.

After receiving the request 412, the mobile communication device 402 may terminate the data call on the first subscription 404 in operation 414. The first subscription 404 may cease use of the transceiver during the handoff process. The mobile communication device 402 may then initiate a handoff from the first subscription 404 to the second subscription 406 in operation 416. The multimode module 410 may then perform a handoff between the second subscription 406 and the network 408 in operation 418. The second subscription 406 may utilize the transceiver (e.g., the transceiver 308) in the mobile communication device 402 to perform the operation 418.

The mobile communication device 402 may determine whether the handoff has succeeded (i.e., whether the second subscription 406 has connected to and acquired service with the network 408). Outcome 450a illustrates the situation in which the handoff succeeds. In the outcome 450a, the handoff is successful and the second subscription 406 becomes active and resumes the data call in operation 420. The multimode module 410 may issue a command 422 to deactivate (i.e., idle) the first subscription 404.

Outcome 450b illustrates the situation in which the handoff does not succeed. For example, a handoff failure may occur when the mobile communication device 402 is close to a cell boundary, which may make it hard for the second subscription 406 to establish a connection with the network 408. In the outcome 450b, the second subscription 406 remains inactive in operation 424 after handoff fails. The multimode module 410 may issue a command 426 to reacquire service on the first subscription 404. The first subscription 404 may reacquire service with the network 408 in operation 428.

During the handoff procedure, neither subscription 404, 406 are in communication with the network 408. Thus, the data call suffers from degraded data throughput during the handoff procedure. For example, in the outcome 450a in which the handoff is successful, the data call is suspended for a time period 430 (corresponding to operations 414-420). In the outcome 450b in which the handoff fails, the data call is suspended for a time period 432 (corresponding to operations 414-418 and 424-428), which is longer than the time period 430. Both time periods 430, 432 may be on the order of several seconds (e.g., 5-15 seconds), which may reduce data throughput.

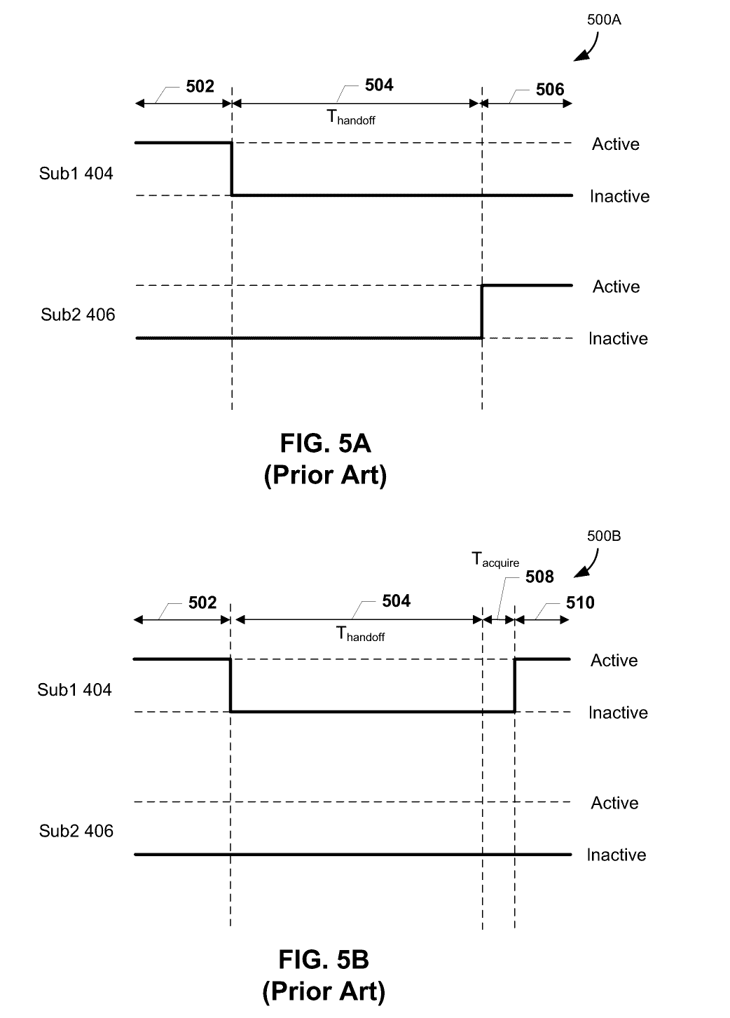

FIGS. 5A and 5B illustrate timing diagrams 500A and 500B for conventional handoff procedures in the mobile communication device 402 (FIG. 4) supporting a first subscription 404 and a second subscription 406. With reference to FIGS. 4-5B, the timing diagram 500A illustrates the outcome when a handoff procedure is successful (e.g., the outcome 450a) while the timing diagram 500B illustrates the outcome when a handoff procedure fails (e.g., the outcome 450b).

In the timing diagram 500A, the first subscription 404 is initially active and the second subscription 406 is initially inactive during a time period 502. During the time period 502, the first subscription 404 may be supporting a data call. The network may send a request to the first subscription 404 to initiate a handoff procedure 504 to the second subscription 406. The first subscription 404 may become inactive during the handoff procedure 504.

During the handoff procedure 504, the second subscription 406 may be performing operations for cell selection and acquiring service from a network base station. For example, the second subscription 406 may scan evolved absolute radio frequency channel numbers (EARFCNs) that are listed in an Inter-RAT re-direct message from the network, and may conduct an acquisition database (ACQ-DB) scan. The handoff procedure 504 may be characterized by a time T_{handoff}, which denotes the amount of time that it takes for the handoff procedure 504 to complete or to fail. The time T_{handoff} may be on the order of seconds (e.g., approximately 1 second for each EARFCN scan and approximately 4 seconds for an ACQ-DB scan). If the handoff procedure 504 is successful, the second subscription 406 becomes active and resumes the data call in a time period 506. During the handoff procedure 504 both subscriptions 404, 406 are inactive, which degrades the data throughput during the handoff procedure 504.

In the timing diagram 500B, the first subscription 404 is initially active and the second subscription 406 is initially inactive during a time period 502. During the time period 502, the first subscription 404 may be supporting a data call. The network may send a request to the first subscription 404 to initiate a handoff procedure 504 to the second subscription 406. The first subscription 404 may become inactive during the handoff procedure 504.

During the handoff procedure 504, the second subscription 406 may attempt to connect with a network base station but fails. The handoff procedure 504 may be characterized by a time T_{handoff} that denotes the amount of time that it takes for the handoff procedure 504 to complete or to fail. If the handoff procedure 504 is unsuccessful, the mobile communication device may attempt to reacquire service using the first subscription 404 in a time period 508. The time period 508 may be characterized by a time T_{acquire} that denotes the amount of time that it takes for the first subscription 404 to acquire service, which may be on the order of hundreds of milliseconds (e.g., approximately 800 milliseconds). The first subscription 404 reacquires service and resumes the data call in a time period 510. During the handoff procedure 504 and the time period 508, both subscriptions 404, 406 are inactive, which degrades the data throughput during both time periods (i.e., T_{handoff}+T_{acquire}).

Various embodiments allow the data call to persist during a handoff procedure, which improves the data throughput of the data call as compared to the conventional methods. This is done by utilizing both the transceiver and the receiver of an RF resource in a mobile communication device to perform the handoff procedure, rather than just the transceiver.

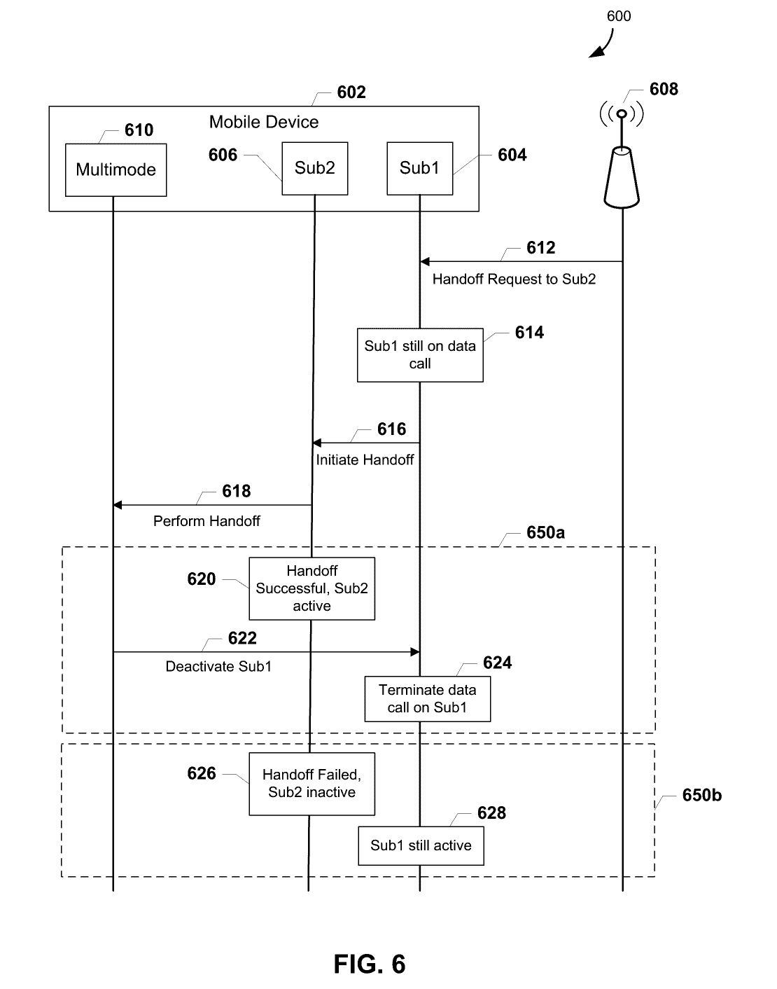

FIG. 6 illustrates a call diagram 600 of communication exchanges during a handoff procedure in a mobile communication device 602 (which may correspond to the mobile communication device 102, 200 in FIGS. 1A-2) according to various embodiments. With reference to FIGS. 1A-3, and 6, the mobile communication device 602 supports a first subscription 604 and a second subscription 606. The mobile communication device 602 may have a communications subsystem that is similar to the communications subsystem 300. For example, the mobile communication device 602 may have a RF resource that includes a transceiver (e.g., the transceiver 308) and a receiver (e.g., the receiver 310).

The first subscription 604 may utilize a RAT with lower data throughput (e.g., GSM) than the RAT of the second subscription 606 (e.g., LTE). The first subscription 604 may communicate with a network 608 to support a data call. A multimode module 610 in the mobile communication device 602 may allow the second subscription 606 to communicate with the network 608. The first subscription 604 and the second subscription 606 may communicate with the same base station of the network 608, or with different base stations controlled by the same network operator.

When the first subscription 604 is active and in communication with the network 608 using a transceiver (e.g., 308) in the mobile communication device, the network 608 may send a request 612 to the first subscription 604 to initiate a handoff procedure to the second subscription 606. For example, the network 408 may determine that a higher data throughput technology (e.g., LTE) is available for the mobile communication device 602 and may request that the mobile communication device 602 switch from the lower data throughput technology to the higher data throughput technology.

After receiving the request 612, the mobile communication device 602 may maintain the data call on the first subscription 604 in operation 614. The data call may be maintained on the transceiver in the mobile communication device 602. The mobile communication device 602 may initiate a handoff from the first subscription 604 to the second subscription 606 in operation 616. The multimode module 610 may perform a handoff between the second subscription 606 and the network 608 in operation 618. The second subscription 606 may utilize a receiver (e.g., the receiver 310) in the mobile communication device 602 to perform the operation 618. Thus, the transceiver of the RF resource in the mobile communication device 602 may be used to maintain the data call on the first subscription 604 while the receiver of the RF resource may be used to perform the handoff procedure to the second subscription 606. This allows the mobile communication device 602 to maintain a higher data throughput during the handoff procedure than if only the transceiver is used to perform the handoff rather than the receiver.

The mobile communication device 602 may determine whether the handoff has succeeded (i.e., whether the second subscription 606 has connected to and acquired service with the network 608). Outcome 650a illustrates the situation in which the handoff succeeds and the second subscription becomes active and resumes the data call in operation 620. The multimode module 610 may issue a command 622 to deactivate (i.e., idle) the first subscription 604. The first subscription 604 may then terminate the data call in operation 624.

Outcome 650b illustrates the situation in which the handoff does not succeed. For example, a handoff failure may occur when the mobile communication device 602 is close to a cell boundary, which may make it hard for the second subscription 606 to establish a connection with a base station of the network 608. In the outcome 650b, the handoff fails and the second subscription remains inactive in operation 626. However, the first subscription 604 is still active and supporting the data call in operation 628, and thus when the handoff procedure fails, the mobile communication device 602 still maintains the data call with minimal interruption. In either of the outcomes 650a, 650b the data call maintains a higher data throughput during a handoff procedure than in the outcomes 450a, 450b of the conventional handoff procedure.

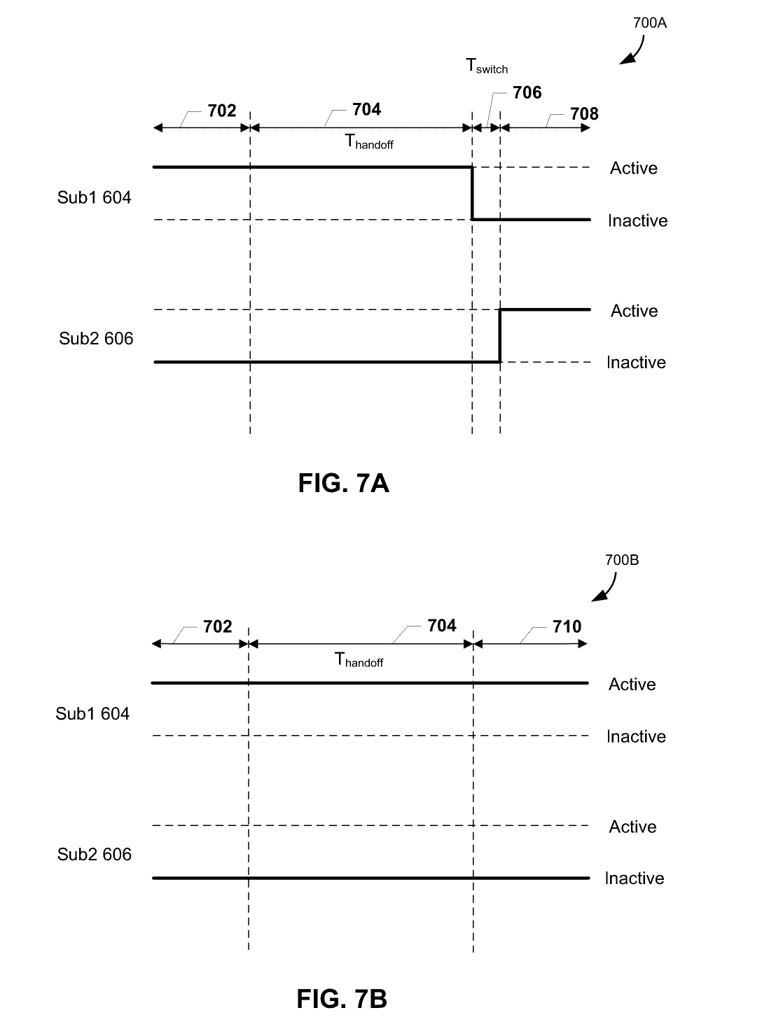

FIGS. 7A and 7B illustrate timing diagrams 700A and 700B for performing handoff procedures in the mobile communication device 602 (FIG. 6) having the first subscription 604 and the second subscription 606 according to various embodiments. With reference to FIGS. 1A-3, and 6-7B, the timing diagram 700A illustrates the outcome when a handoff procedure is successful (e.g., the outcome 650a) while the timing diagram 700B illustrates the outcome when a handoff procedure fails (e.g., the outcome 650b).

In the timing diagram 700A, the first subscription 604 is initially active and the second subscription 606 is initially inactive during a time period 702. During the time period 702, the first subscription 604 may be supporting a data call. The network may send a request to the first subscription 604 to initiate a handoff procedure 704 to the second subscription 606. The first subscription 604 may remain active in the handoff procedure 704 by using a transceiver (e.g., the transceiver 308) in the mobile communication device.

During the handoff procedure 704, the second subscription 606 may be performing operations for cell selection and acquiring service from a network base station using a separate receiver (e.g., the receiver 310) in the mobile communication device. For example, the second subscription 406 may scan EARFCNs that are listed in an Inter-RAT re-direct message from the network, and may conduct an ACQ-DB scan. The handoff procedure 704 may be characterized by a time T_{handoff} that denotes the amount of time that it takes for the handoff procedure 704 to complete or to fail. The time T_{handoff} may be on the order of seconds (e.g., approximately 1 second for each EARFCN scan and approximately 4 seconds for a ACQ-DB scan). If the handoff procedure 704 is successful, the mobile communication device may initiate a switch from the first subscription 604 to the second subscription 606 in a time period 706. The time period 706 may be characterized by a time T_{switch} that denotes the amount of time that it takes for the mobile communication device to switch communications from the receiver to the transceiver, which may be on the order of milliseconds. The second subscription 606 becomes active and resumes the data call in a time period 708. Thus, when the handoff procedure 704 is successful, the data call is only interrupted for a short time period (i.e., T_{switch}) as compared to the situation illustrated in the timing diagram 500A in which the data call is interrupted for a longer time period (i.e., T_{handoff}).

In the timing diagram 700B, the first subscription 604 is initially active and the second subscription 606 is initially inactive during a time period 702. During the time period 702, the first subscription 604 may be supporting a data call. The network may send a request to the first subscription 604 to initiate a handoff procedure 704 to the second subscription 606. The first subscription 604 may remain active in the handoff procedure 704 by using a transceiver (e.g., the transceiver 308) in the mobile communication device.

During the handoff procedure 704, the second subscription 606 may be performing operations for cell selection and acquiring service from a network base station using a separate receiver (e.g., the receiver 310) in the mobile communication device. The handoff procedure 704 may be characterized by a time T_{handoff} which denotes the amount of time that it takes for the handoff procedure 704 to complete or to fail. If the handoff procedure 704 fails, the mobile communication device may continue to maintain the data call on the first subscription 604 in a time period 710. Thus, when the handoff procedure 704 fails, the data call does not experience any interruption as compared to the situation illustrated in the timing diagram 500B in which the data call is interrupted for a certain time period (i.e., T_{handoff}+T_{acquire}) as the mobile communication device tries to reacquire service using the first subscription 404 after failure of the handoff procedure 504.

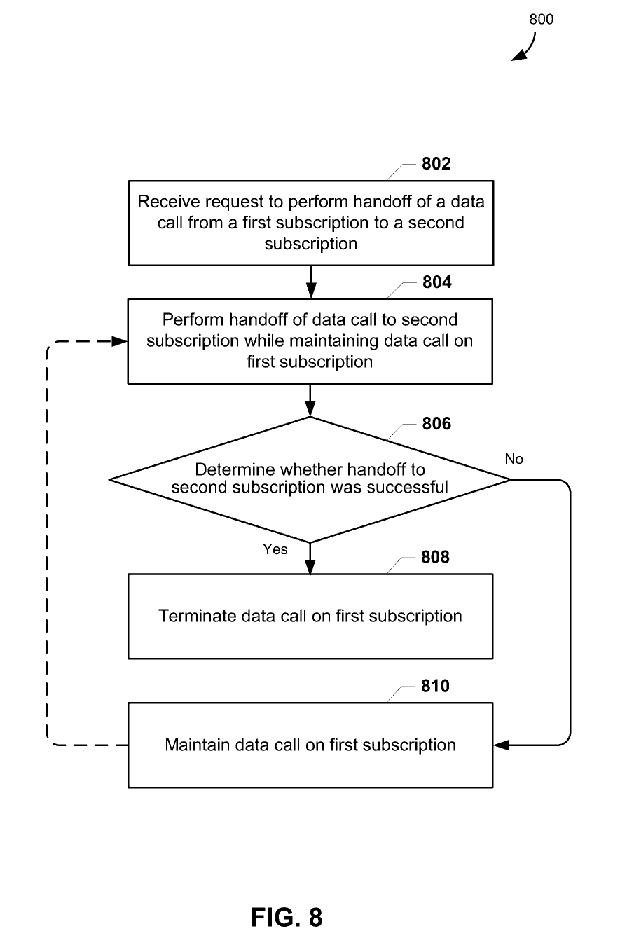

FIG. 8 illustrates a method 800 for performing a handoff procedure on a mobile communication device according to various embodiments. With reference to FIGS. 1A-3, and 6-8, the operations of the method 800 may be implemented by one or more processors of the mobile communication device 200, such as a general-purpose processor 206, a baseband modem processor(s) 216, or a separate controller (not shown) that may be coupled to the memory 214 and to the baseband modem processor(s) 216. The mobile communication device may include a first subscription and a second subscription. The mobile communication device may have a communications subsystem (e.g., the communications subsystem 300) that has an RF resource including both a transceiver and a receiver.

In block 802, the device processor may receive a request from a network to perform a handoff of a data call from the first subscription to the second subscription. The first subscription may be currently active and supporting the data call. The first subscription may be communicating through a lower data throughput RAT (e.g., GSM) than the second subscription (e.g., LTE). The first subscription may be utilizing a transceiver of the RF resource to support the data call. The second subscription may be capable of utilizing both the transceiver and the receiver of the RF resource (e.g., the second subscription is capable of carrier aggregation).

In block 804, the device processor may perform the handoff of the data call to the second subscription while maintaining the data call on the first subscription. The second subscription may utilize the receiver of the RF resource to perform the handoff while the first subscription continues to utilize the transceiver to maintain the data call. This allows the mobile communication device to maintain a higher data throughput during the handoff procedure than if the first subscription were forced to suspend communication and give the transceiver to the second subscription for the handoff.

In determination block 806, the device processor may determine whether the handoff of the data call to the second subscription was successful. For example, the device processor may determine whether the second subscription has established a connection with a network base station and registered with the network.

In response to determining that the handoff of the data call to the second subscription was successful (i.e., determination block 806=“Yes”), the device processor may terminate the data call on the first subscription in block 808. Terminating the data call of the first subscription may include terminating the data call maintained by the first subscription on the transceiver and allowing the second subscription to switch from the receiver to the transceiver to establish the data call. This results in the second subscription being the sole subscription supporting the data call.

In response to determining that the handoff of the data call to the second subscription was not successful (i.e., determination block 806=“No”), the device processor may maintain the data call on the first subscription in block 810. Thus if the handoff to the second subscription fails, the mobile communication device may simply continue to use the first subscription for the data call without any service interruption. The device processor may optionally re-attempt the handoff of the data call to the second subscription (i.e., perform the operations in block 804 again). In this manner, the method 800 minimizes service interruptions to a data call during a handoff procedure.

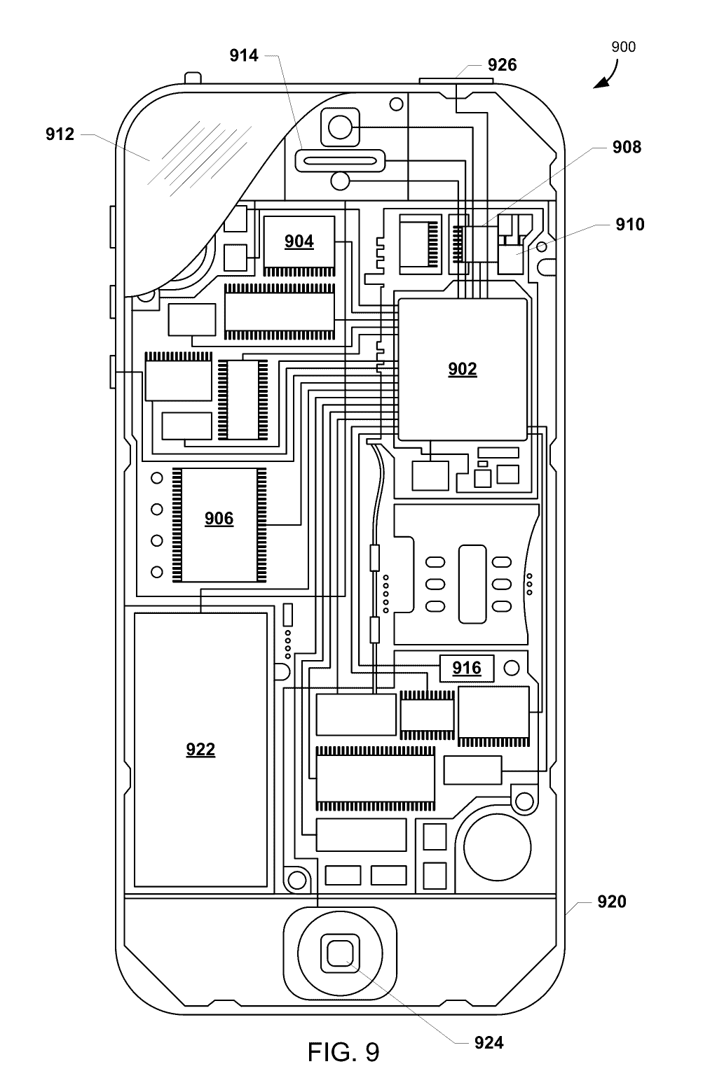

Various embodiments may be implemented in any of a variety of computing devices, an example of which (e.g., mobile communication device 900) is illustrated in FIG. 9. With reference to FIGS. 1-3 and 6-9, the mobile communication device 900 may be similar to the mobile communication devices 102, 200, and 602 as described. As such, the mobile communication device 900 may implement the method 800 according to various embodiments.

A mobile communication device 900 may include a processor 902 coupled to a touchscreen controller 904 and an internal memory 906. The processor 902 may be one or more multi-core integrated circuits designated for general or specific processing tasks. The internal memory 906 may be volatile or non-volatile memory, and may also be secure and/or encrypted memory, or unsecure and/or unencrypted memory, or any combination thereof. The touchscreen controller 904 and the processor 902 may also be coupled to a touchscreen panel 912, such as a resistive-sensing touchscreen, capacitive-sensing touchscreen, infrared sensing touchscreen, etc. Additionally, the display of the mobile communication device 900 need not have touch screen capability.

The mobile communication device 900 may have one or more cellular network transceivers 908 coupled to the processor 902 and to one or more antennas 910 and configured for sending and receiving cellular communications. The one or more transceivers 908 and the one or more antennas 910 may be used with the previously-mentioned circuitry to implement various embodiment methods. The mobile communication device 900 may include one or more SIM cards 916 coupled to the one or more transceivers 908 and/or the processor 902 and may be configured as described herein.

The mobile communication device 900 may also include speakers 914 for providing audio outputs. The mobile communication device 900 may also include a housing 920, constructed of a plastic, metal, or a combination of materials, for containing all or some of the components discussed herein. The mobile communication device 900 may include a power source 922 coupled to the processor 902, such as a disposable or rechargeable battery. The rechargeable battery may also be coupled to the peripheral device connection port to receive a charging current from a source external to the mobile communication device 900. The mobile communication device 900 may also include a physical button 924 for receiving user inputs. The mobile communication device 900 may also include a power button 926 for turning the mobile communication device 900 on and off.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a SIM and data receiving associated with a different SIM, such identifiers are merely for convenience and are not meant to limit various embodiments to a particular order, sequence, type of network or carrier.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present embodiments.

The hardware used to implement the various illustrative logics, logical blocks, modules, and circuits described in connection with the aspects disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, Flash memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc in which disks usually reproduce data magnetically, while discs reproduce data optically with lasers. Combinations of such storage media are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A method of performing a handoff from a first subscription on a mobile communication device to a second subscription, the mobile communication device having a transceiver and a receiver, comprising:
receiving, on the mobile communication device, a request from a network to perform the handoff of a data call from the first subscription to the second subscription;
performing, via the receiver, the handoff of the data call to the second subscription while maintaining, via the transceiver, the data call on the first subscription during the handoff of the data call to the second subscription;
determining whether the handoff of the data call to the second subscription was successful; and
terminating the data call on the first subscription in response to determining that the handoff of the data call to the second subscription was successful.

2. The method of claim 1, wherein terminating the data call on the first subscription comprises:
terminating the data call maintained by the first subscription via the transceiver; and
establishing the data call on the transceiver through the second subscription.

3. The method of claim 1, further comprising maintaining the data call on the first subscription in response to determining that the handoff of the data call to the second subscription has not succeeded.

4. The method of claim 1, wherein the first subscription is associated with a first radio access technology (RAT) and the second subscription is associated with a second RAT.

5. The method of claim 4, wherein the second RAT has a higher data throughput than the first RAT.

6. The method of claim 4, wherein the transceiver is utilized by the first RAT and the second RAT, and the receiver is utilized by the second RAT.

7. A mobile communication device, comprising:
a memory;
a radio frequency (RF) resource comprising a transceiver and a receiver;
a processor coupled to the memory and the RF resource, configured to connect to a first subscriber identity module (SIM) associated with a first subscription and to a second SIM associated with a second subscription, and configured with processor-executable instructions to:
receive a request from a network to perform a handoff of a data call from the first subscription to the second subscription;
perform, via the receiver, the handoff of the data call to the second subscription while maintaining, via the transceiver, the data call on the first subscription during the handoff of the data call to the second subscription;
determine whether the handoff of the data call to the second subscription was successful; and
terminate the data call on the first subscription in response to determining that the handoff of the data call to the second subscription was successful.

8. The mobile communication device of claim 7, wherein the processor is further configured with processor-executable instructions to terminate the data call on the first subscription by:
terminating the data call maintained by the first subscription via the transceiver; and
establishing the data call on the transceiver through the second subscription.

9. The mobile communication device of claim 7, wherein the processor is further configured with processor-executable instructions to maintain the data call on the first subscription in response to determining that the handoff of the data call to the second subscription has not succeeded.

10. The mobile communication device of claim 7, wherein the first subscription is associated with a first radio access technology (RAT) and the second subscription is associated with a second RAT.

11. The mobile communication device of claim 10, wherein the second RAT has a higher data throughput than the first RAT.

12. The mobile communication device of claim 10, wherein the transceiver is utilized by the first RAT and the second RAT, and the receiver is utilized by the second RAT.

13. A non-transitory computer readable storage medium having stored thereon processor-executable software instructions configured to cause a processor of a mobile communication device to perform operations comprising:
receiving, on the mobile communication device, a request from a network to perform a handoff of a data call from a first subscription of the mobile communication device to a second subscription of the mobile communication device, wherein the mobile communication device has a transceiver and a receiver;
performing, via the receiver, the handoff of the data call to the second subscription while maintaining, via the transceiver, the data call on the first subscription during the handoff of the data call to the second subscription
determining whether the handoff of the data call to the second subscription was successful; and
terminating the data call on the first subscription in response to determining that the handoff of the data call to the second subscription was successful.

14. The non-transitory computer readable storage medium of claim 13, wherein the stored processor-executable software instructions are further configured such that terminating the data call on the first subscription comprises:
terminating the data call maintained by the first subscription via the transceiver; and
establishing the data call on the transceiver through the second subscription.

15. The non-transitory computer readable storage medium of claim 13, wherein the stored processor-executable software instructions are configured to cause the processor to perform operations further comprising maintaining the data call on the first subscription in response to determining that the handoff of the data call to the second subscription has not succeeded.

16. The non-transitory computer readable storage medium of claim 13, wherein the first subscription is associated with a first radio access technology (RAT) and the second subscription is associated with a second RAT.

17. The non-transitory computer readable storage medium of claim 16, wherein the second RAT has a higher data throughput than the first RAT.

18. The non-transitory computer readable storage medium of claim 16, wherein the transceiver is utilized by the first RAT and the second RAT, and the receiver is utilized by the second RAT.

19. A mobile communication device, comprising:
means for receiving, on the mobile communication device, a request from a network to perform a handoff of a data call from a first subscription of the mobile communication device to a second subscription of the mobile communication device, wherein the mobile communication device has a transceiver and a receiver;
means for performing, via the receiver, the handoff of the data call to the second subscription while maintaining, via the transceiver, the data call on the first subscription during the handoff of the data call to the second subscription;
means for determining whether the handoff of the data call to the second subscription was successful; and
means for terminating the data call on the first subscription in response to determining that the handoff of the data call to the second subscription was successful.
